(19) United States
(12) Patent Application Publication
(10) Pub. No.: US 2008/0097798 A1
(43) Pub. Date: Apr. 24, 2008

(54) Method and System for Creating and Processing Rental Vehicle Reservations Using Vouchers

(75) Inventors: Kimberly A. DeVallance, St. Louis, MO (US); Mary C. Larner, Maryville, IL (US); Gregory D. Petersen, Surrey (GB); Craig L. Botwin, Surrey (GB)

Correspondence Address: THOMPSON COBURN, LLP, ONE US BANK PLAZA, SUITE 3500, ST LOUIS, MO, 63101, US

(73) Assignee: The Crawford Group, Inc., St. Louis, MO (US)

(21) Appl. No.: 11/550,614

(22) Filed: Oct. 18, 2006

(51) Int. Cl. G06Q 10/00

(52) U.S. Cl. 705/5

(57) ABSTRACT

Systems and methods are disclosed herein for creating and managing rental vehicle reservations. According to one embodiment, a system is disclosed for creating and managing a rental vehicle reservation, the system comprising: (a) a user computer, and (b) a reservation computer system that is in communication with the user computer via a network, and wherein the reservation computer system is configured to accept input from a user of the user computer over the network to create a pended rental vehicle reservation for storage and processing by the reservation computer system. The inventors herein believe that the ability of a reservation computer system to maintain such a pended status for rental vehicle reservations is particularly useful in connection with processing vouchers for replacement rental vehicles.

### CROSS REFERENCE TO RELATED PATENT APPLICATIONS

This application is related to the following pending U.S. patent applications: (1) U.S. patent application Ser. No. 09/641,820, filed Aug. 18, 2000, (2) U.S. patent application Ser. No. 09/694,050, filed Oct. 20, 2000, (3) U.S. patent application Ser. No. 10/028,073, filed Dec. 26, 2001, and published as U.S. patent application publication 2003/0125992, (4) U.S. patent application Ser. No. 10/343,576, filed Jan. 31, 2003 (which is a national phase of PCT patent application serial number PCT/US01/51437, filed Oct. 19, 2001), and published as U.S. patent application publication 2005/0021378, and (5) U.S. patent application Ser. No. 10/865,116, filed Jun. 10, 2004, and published as U.S. patent application publication 2005/0091087, the entire disclosures of each of which are incorporated herein by reference.

### FIELD OF THE INVENTION

The present invention relates generally to the field of creating and managing rental vehicle reservations, including rental vehicle reservations booked on behalf of customers to whom a voucher for a rental vehicle is provided.

### BACKGROUND AND SUMMARY OF THE INVENTION

A significant market in the rental vehicle industry is the replacement rental vehicle market. With replacement rental vehicles, drivers who are involved in an accident or whose ordinary vehicles are otherwise damaged and/or undriveable will drive a replacement rental vehicle for some specified period of time while their ordinary vehicle is undergoing repairs. The insurance companies that provide replacement rental vehicles to insureds/claimants as part of the automobile insurance claims process thus represent important customers for rental vehicle service providers.

To serve the needs of the replacement rental vehicle market, the assignee of the present invention has previously developed an automated rental vehicle reservation management system, known as the ARMS® system (hereinafter “ARMS” or the “ARMS system”). The above-referenced related patent applications describe various embodiments of the ARMS system. In short, through a preferred embodiment of the ARMS system, a business partner of the rental vehicle service provider can use its own Internet-connected computer to access various graphical user interface (GUI) screens available through the ARMS system to create and manage replacement rental vehicle reservations on behalf of third parties. Thus, in situations where the business partner is an insurance company, an insurance company employee (e.g., an insurance adjuster) is effectively provided with the ability to remotely create and manage rental vehicle reservations with the rental vehicle service provider on behalf of insureds/claimants as if that insurance company employee were himself/herself an employee of the rental vehicle service provider.

When processing an insurance claim, it is relatively common for the insurance adjuster to cut a check to the insured/claimant in an amount sufficient to cover the cost for a replacement rental vehicle to be driven by the insured/claimant. However, experience has shown that it is not uncommon for insureds/claimants to cash such checks without ever picking up their replacement rental vehicles. In such circumstances, the insured/claimant may have found alternate means of transportation (a spouse's car, public transportation, etc.) or may have chosen to do without a car for a few days. From the perspective of the insurance company, such diversion of insurance payouts constitutes a money loss that could have been prevented.

In an effort to contain costs corresponding to diverted replacement rental vehicle money, many insurance companies have adopted a voucher-based system of booking replacement rental vehicles for insureds/claimants. With a voucher-based system, insurance companies provide insureds/claimants with a voucher for a replacement rental vehicle instead of a check to be cashed and applied against a replacement rental vehicle. The insured/claimant can then present this voucher to the rental vehicle service provider to pick up his/her replacement rental vehicle if and when the insured/claimant chooses to do so. The rental vehicle service provider can then bill the insurance company for the replacement rental vehicle in accordance with the terms of the voucher. With such a voucher-based system, insurance companies can avoid making replacement rental vehicle cash payouts to insureds/claimants when those insured/claimants never actually rent the replacement rental vehicle. However, the use of simple manually processed paper vouchers in connection with replacement rental vehicle reservations can create burdens on insurance companies and rental vehicle service providers due to the blizzard of paperwork that is needed to process the vouchers when such a voucher program is deployed on a large scale.

Furthermore, the use of such vouchers by insurance companies who use an automated rental vehicle reservation management system such as the ARMS system presents some difficulties. For example, if an insurance adjuster concurrently creates a replacement rental vehicle voucher for an insured/claimant and books a rental vehicle reservation corresponding to the voucher through the ARMS system, a situation may develop where a reservation held by the rental vehicle service provider for the insured/claimant never gets fulfilled because the insured/claimant chooses not to “cash in” his/her voucher. Such a situation creates operating inefficiencies on the part of the rental vehicle service provider as it holds a rental vehicle reservation open for a customer who may never arrive and the rental vehicle service provider may also hold or even prep a rental vehicle that never gets picked up (e.g., cleaning, fueling and otherwise preparing the rental vehicle for pick up by the renter). However, an alternative solution wherein the insurance adjuster does not actually create the replacement rental vehicle reservation in the ARMS system until the insured/claimant contacts the adjuster to notify the adjuster of his/her intention to actually cash in the voucher creates inefficiency in that the adjuster must then return to the claim file for the insured/claimant to process the reservation in accordance with the voucher.

In an effort to address these issues, the inventors herein disclose a system and method whereby business partners of a rental vehicle service provider can create a new type of rental vehicle reservation having a pended status. As used herein, a “pended” reservation refers to a reservation for which the appropriate constituent information has been entered into the rental vehicle service provider's reservation computer system (e.g., renter name, authorization period, branch location where the rental vehicle is to be picked up by the customer), but for which the reservation computer system does not recognize as being eligible for fulfillment until some secondary action occurs. Preferably, this secondary action comprises an activation of the pended reservation by a person having appropriate approval authority. The secondary action may also take other forms, including but not limited to an activation by an automatic process in response to receiving an indication from the voucher holder (or some other person) that the voucher holder intends to actually use the voucher. A pended reservation can also be referred to as a “pended authorization for a reservation”. Essentially, a pended reservation is a reservation that is “on hold” until activated. Upon activation, the pended reservation is released, or “unpended”, such that the reservation is now eligible to be fulfilled by the customer. In essence, when a pended reservation is “unpended”, it is transformed into a standard reservation and processed as any other standard reservation. Thus, when a pended reservation has been unpended, a rental vehicle service provider can then open a rental ticket for a customer who arrives to pick up his/her rental vehicle in accordance with the terms of the unpended reservation.

As indicated, a preferred business partner of the rental vehicle service provider for use with this invention is an insurance company that books and manages replacement rental vehicles for insureds and claimants. By introducing the pended status to rental vehicle reservations, the inventors herein believe that the efficiency of both insurance adjusters and rental vehicle service providers can be improved in connection with processing vouchers for replacement rental vehicles, while still providing insurance companies with the cost containment advantages of vouchers. Furthermore, the inventors herein further disclose that in an embodiment wherein the new pended status of reservations is incorporated into an automated rental vehicle reservation management system such as the ARMS system referenced above, business partners who use the automated rental vehicle reservation management system are provided with powerful new capabilities to not only create and manage standard rental vehicle reservations but to also create and manage pended rental vehicle reservations. With such an embodiment, separate processing systems do not need to be used and maintained to create and manage those two types of reservations (standard and pended); business partners can use the same automated rental vehicle reservation management system for both tasks, thereby providing business partners with greatly improved operating efficiencies, particularly when the large volume nature of the replacement rental vehicle market is considered.

The inventors further disclose that the pended status of rental vehicle reservations can be used to implement the workflows of business partners, wherein those business partners have personnel who create and manage rental vehicle reservations and who possess differing levels of approval authority with regard to the creation and management of such reservations.

These and other features and advantages of the present invention will be apparent to those having ordinary skill in the art upon review of the specification and drawings contained herein.

### BRIEF DESCRIPTION OF THE DRAWINGS

FIG. 1 is block diagram overview of a system in accordance with a preferred embodiment of the present invention;

FIG. 2 illustrates an exemplary process flow for creating a pended rental vehicle reservation and a voucher therefor;

FIGS. 3(a)-(d) illustrate exemplary process flows for activating a pended rental vehicle reservation using a voucher;

FIGS. 4(a) and (b) illustrate exemplary GUI screenshots for creating a pended rental vehicle reservation;

FIGS. 5(a) and (b) illustrate exemplary GUI screenshots for performing a search for existing pended rental vehicle reservations;

FIGS. 6(a) and (b) illustrate an exemplary GUI screenshot for cancelling a pended rental vehicle reservation;

FIG. 7 illustrates the exemplary system of FIG. 1 wherein the reservation system is a first embodiment of an automated rental vehicle reservation management system;

FIG. 8 illustrates the exemplary system of FIG. 1 wherein the reservation system is a second embodiment of an automated rental vehicle reservation management system;

FIG. 9 illustrates an exemplary process flow for allocating approval authority for different users to create pended rental vehicle reservations and activate pended rental vehicle reservations; and

FIG. 10 illustrates an exemplary workflow in accordance with the process flow of FIG. 9;

### DETAILED DESCRIPTION OF THE PREFERRED EMBODIMENT

FIG. 1 depicts a system 100 in accordance with a preferred embodiment of the invention. System 100 preferably comprises a business partner computer 102 that is in communication with a rental vehicle reservation system 106 (preferably an automated rental vehicle reservation management system operated by a rental vehicle service provider) via a communications network 104 (preferably the Internet). Through computer 102's connection to network 104, a user of computer 102 can preferably access one or more GUI screens available through the reservation system 106, wherein such one or more GUI screens are configured to provide the user with the ability to book (and preferably manage) rental vehicle reservations with the rental vehicle service provider that operates system 106.

As explained above, reservation system 106 is preferably an automated rental vehicle reservation management system such as the ones described in the above-referenced and incorporated related patent applications, augmented with the features described herein. As explained above and in the referenced patent applications, the preferred automated rental vehicle reservation management system is configured to provide a user of the business partner computer 102 with the ability to remotely create and manage rental vehicle reservations with the rental car company as if that user were himself/herself an employee of the rental car company.

As also explained above, it is often the case that the user of the business partner computer system 102 will be booking rental vehicle reservations on behalf of a third party. This is particularly true in the collision repair industry, wherein insurance companies routinely provide replacement rental vehicles to insureds and claimants as part of the automobile insurance claims process. Thus, with system 100, the business partner of the rental vehicle service provider that operates computer 102 could be an insurance company. In such cases, the user of computer 102 may be an insurance adjuster who in turn accesses the automated rental vehicle reservation management system 106 to create and manage reservations for replacement rental vehicles on behalf of insureds/claimants. As explained herein, system 100 can be used to create and manage voucher-based replacement rental vehicle reservations.

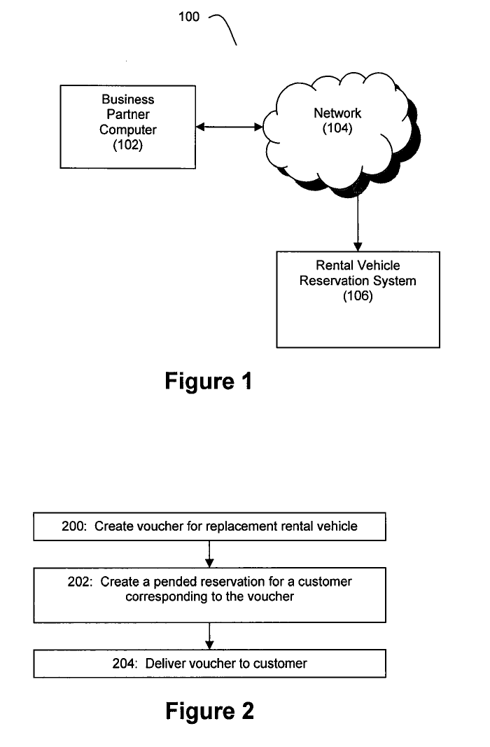

FIG. 2 depicts a preferred flow for creating a pended rental vehicle reservation and a voucher therefor. At step 200, an insurance company representative (preferably an insurance adjuster) creates a voucher for a rental vehicle reservation. This voucher can then be used by an insured/claimant to pick up a rental vehicle to be billed against the insurance company in accordance with the terms of the voucher. The voucher preferably identifies a name for the insured/claimant who is eligible to rent the replacement rental vehicle. The voucher also preferably includes some form of identifier for identifying the voucher and any rental vehicle reservation corresponding thereto (e.g., an insurance claim number, a voucher number, or some other identifier). The voucher also preferably identifies a vehicle class and rental term (the number of days authorized for the rental) that have been authorized for the replacement rental vehicle corresponding thereto.

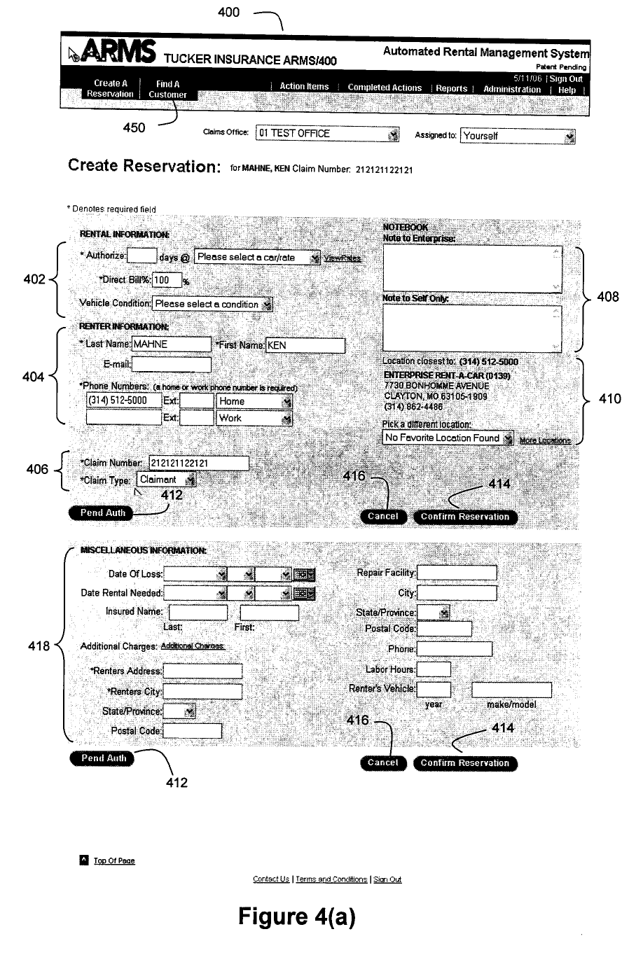

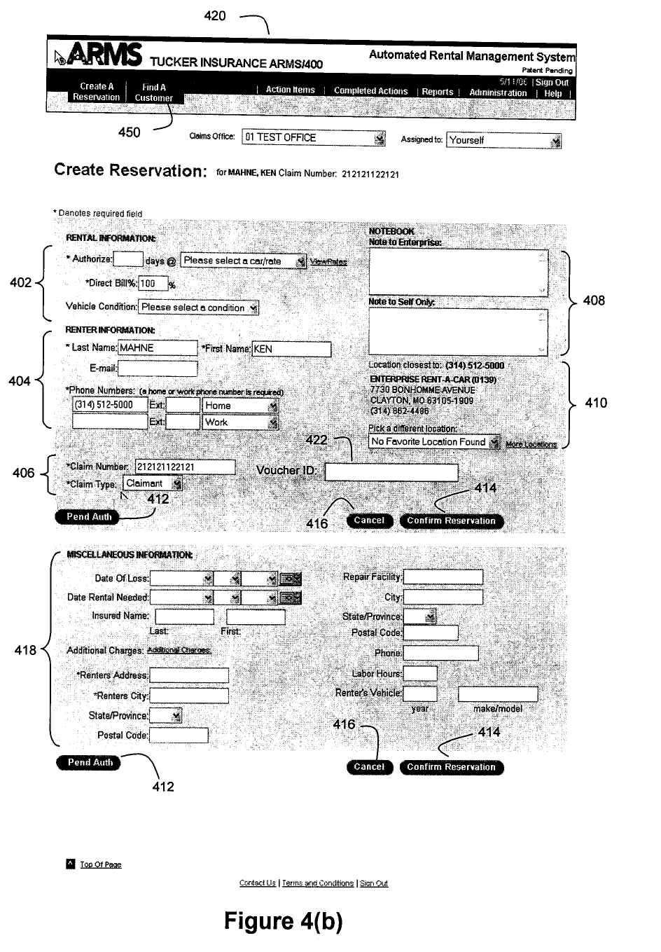

Next, at step 202, the adjuster or other authorized user accesses the automated rental vehicle reservation system 106 through his/her computer 102 to book a pended rental vehicle reservation with a rental vehicle service provider. FIG. 4(a) depicts an exemplary GUI screen 400 through which an authorized user of computer 102 can create a pended reservation via the automated rental vehicle reservation management system 106.

Screen 400 preferably includes a plurality of fields in which the user can enter pertinent information for the replacement rental vehicle reservation. Through fields 402, the user can (1) enter an authorization period for the renter's replacement rental vehicle, (2) select a vehicle type and vehicle price rate for the renter's replacement rental vehicle, (3) select a percentage of the cost for the replacement rental vehicle to be billed to the insurance company, and (4) select a vehicle condition for the renter's ordinary but damaged vehicle (e.g., driveable, undriveable, totaled, etc.)

Through fields 404, the user can enter various information regarding the renter, preferably including first and last name, email address, and contact phone numbers.

Through fields 406, the user can preferably enter an insurance claim number that is applicable to the replacement rental vehicle. The user is also preferably provided with the ability to identify whether the renter is the insured or a claimant with respect to the insurance claim.

Through fields 408, the user has the option of entering notes for the rental vehicle service provider or for himself/herself to be stored in association with the reservation.

Through section 410, the user can select a branch location of a rental vehicle service provider where the replacement rental vehicle is to be picked up by the insured/claimant. Preferably, the branch location that is deemed to be closest to a location corresponding to some criteria (e.g., the insured's/claimant's telephone number, the insured's/claimant's home address or zip code, the repair facility where the insured's/claimant's ordinary vehicle is undergoing repairs, etc.) is the automatically selected default location, although the user preferably has the ability to choose a different branch location if desired.

A variety of additional miscellaneous fields 418 can also be filled in by the user if desired.

If the user wants to move forward and book a rental vehicle reservation in accordance with the information entered via screen 400, the user can do so by selecting the “confirm reservation” button 414. The selection of button 414 is preferably effective to automatically book the rental vehicle reservation with the rental vehicle service provider. With such a confirmed reservation, the rental vehicle service provider can then open a rental ticket in accordance with the confirmed reservation when the insured/claimant arrives at the rental branch location to pick up his/her rental vehicle.

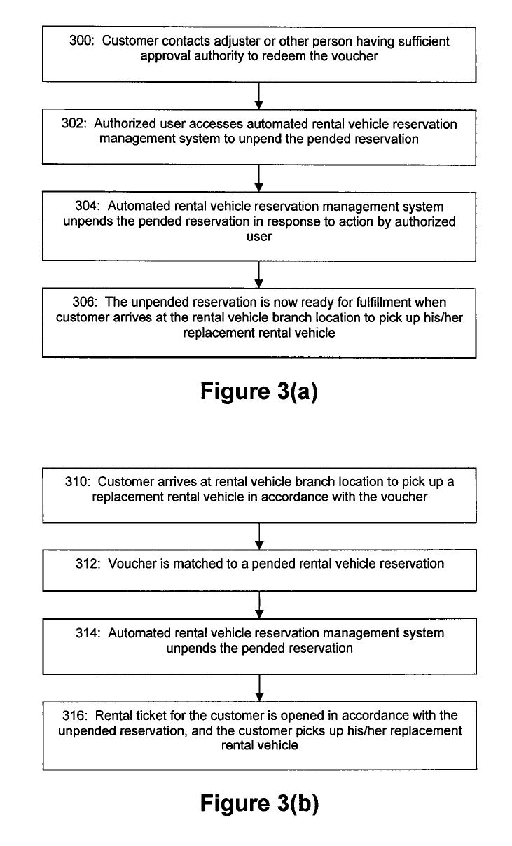

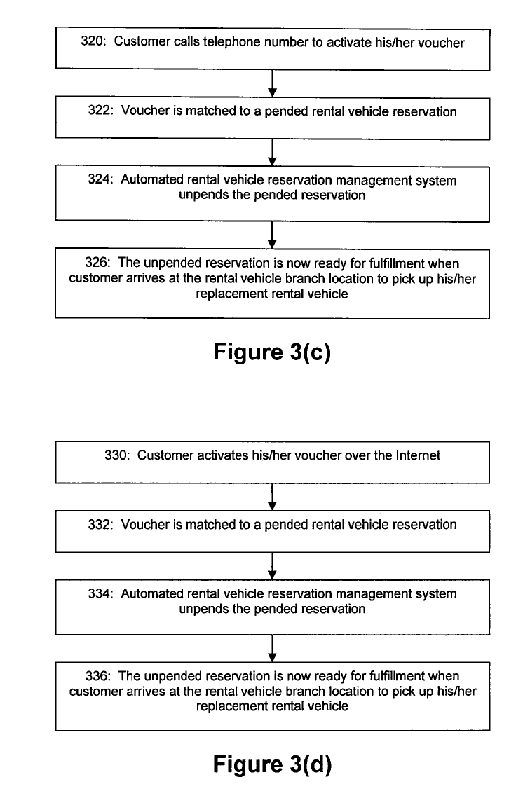

However, as explained above, many insurance companies would prefer to use a voucher-based system when renting vehicles on behalf of insureds/claimants. When a user enters information through screen 400 for a rental vehicle reservation corresponding to a voucher, the user preferably selects the “pend authorization” button 412 when first creating the reservation. The selection of button 412 is preferably effective to automatically store a pended rental vehicle reservation in a database of the automated rental vehicle reservation management system 106. With such a pended reservation, the insured/claimant will not be able to pick up his/her rental vehicle until the pended reservation has been activated, as explained below in connection with FIGS. 3(a)-(d). However, by allowing the user to create a pended reservation concurrently with his/her creation of a voucher, it is believed that the efficiency of the user can be improved in that the user can take care of both the voucher and the data entry-intensive aspects of the replacement rental vehicle reservation at the same time.

FIG. 4(b) depicts an alternate GUI screen 420 for creating a pended rental vehicle reservation. Screen 420 preferably includes a field 422 in which the user can enter a voucher identifier that serves to identify the voucher that was created for the insured/claimant (which may be useful for business partners that do not wish to use the claim number as the voucher identifier). Upon selection of the “pend authorization” button 412, the automated rental vehicle reservation management system 106 can then also store the voucher identifier in association with the pended reservation.

Returning to FIG. 2, once the voucher has been created and the pended reservation has been booked, the voucher can be delivered to the customer (step 204). The voucher can be delivered to the customer in any of a number of forms. For example, a paper voucher can be provided to the customer, wherein the paper voucher identifies the basic terms of the replacement rental vehicle reservation that the customer has the option of picking up. The voucher also preferably informs that customer as to how the voucher can be “cashed in” or activated. Preferably, the voucher will include some form of identifier that allows the insurance company or rental vehicle service provider to identify the pended reservation corresponding thereto (preferred examples of such identifiers being a claim number and/or a voucher number). As another example, the voucher can be electronically delivered to the customer, through for example email.

It should be noted that steps 200 and 202 could readily be reversed in their order of execution, wherein step 202 could be performed prior to step 200 (similarly, it should be readily understood that step 204 could be performed prior to step 202). However, it is preferred that steps 200 and 202 be performed relatively concurrently in order to increase the efficiency of the adjuster.

Once the voucher has been delivered to the customer, the customer then has the option to decide whether or not to use the voucher to pick up a replacement rental vehicle. FIGS. 3(a)-(d) describe various methods that can be used to activate pended rental vehicle reservations corresponding to vouchers.

FIG. 3(a) depicts a process flow for a first exemplary method of activating a pended rental vehicle reservation corresponding to a voucher. At step 300, the customer contacts the adjuster (or some other designated person with sufficient authority) to inform the adjuster that he/she will be using the voucher to pick up his/her replacement rental vehicle. This contact can be via telephone, email, or other modes of communication. Preferably, the voucher delivered to the customer at step 204 of FIG. 2 will identify a means for contacting the insurance adjuster or other designated person (a telephone, email address, etc.).

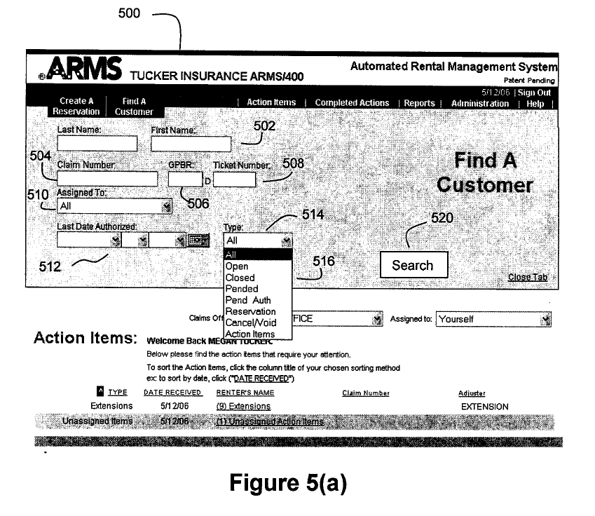

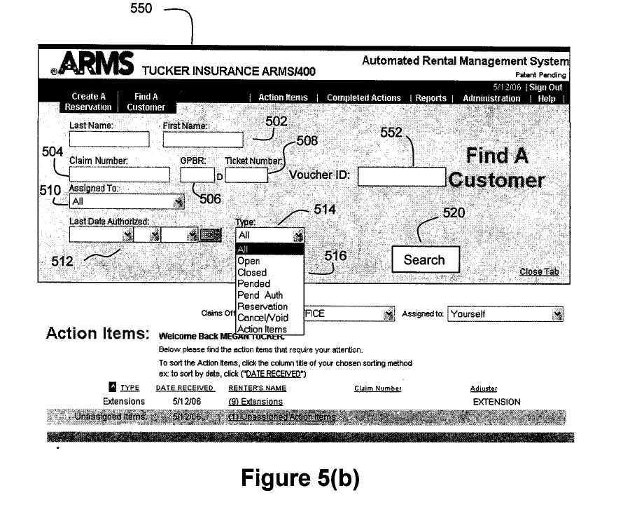

Next, at step 302, the an authorized user (e.g., the adjuster) accesses the automated rental vehicle reservation management system 106 via his/her computer 102 as shown in FIG. 1. With reference to FIGS. 4(a) and (b), various GUI screens encountered by the user when the user logs into the reservation system 106 will include a button 450 that is selectable to display a “Find A Customer” GUI screen, such as the ones shown in FIGS. 5(a) and (b). Screen 500 of FIG. 5(a) includes a variety of data fields in which the adjuster can enter search criteria to pull up the reservation corresponding to the customer. For example, through fields 502, the user can search by the customer's name. Through field 504, the user can search by claim number. Through field 506, the user can search by the branch location at which the replacement rental vehicle is to picked up by the customer. Through field 508, the user can search by rental ticket number (although such searches are not likely to be needed in connection with the flow of FIG. 3(a) because there is preferably not a rental ticket opened up until after the user unpends the pended reservation). Through field 510, the user can search for all reservations that have been assigned to a particular adjuster (including himself/herself). Through fields 512, the user can preferably search by the last date that has been authorized for the reservation. Lastly, through field 514, the user can specify the type of reservations to be searched. Preferably, the reservation type selected in field 514 as part of step 302 is the “pended authorization” reservation type. Upon entering the appropriate search criteria on screen 500, the user can then select the “search” button 520 to search the automated rental vehicle reservation management system for pended reservations that meet the specified criteria.

FIG. 5(b) depicts an alternate “Find A Customer” screen 550 that includes a field 552 in which the user can specify a voucher identifier for use as a search constraint.

If multiple reservations meet the specified search criteria, a screen (not shown) can be displayed on computer 102 that lists all such reservations so that the user can then select which reservation on the list is appropriate. Once the individual pended reservation corresponding to the customer's voucher has been identified by the user, the screen of FIG. 4(a) (or FIG. 4(b)) is preferably once again displayed. From the screen of FIG. 4(a) (or FIG. 4(b)), the user can review the terms of the pended reservation corresponding to the voucher and decide whether the reservation should be confirmed. If it is to be confirmed, the user can do so by selecting the “Confirm Reservation” button 414 as explained above. The user at this time can also make any modifications to the reservation that may be appropriate (e.g., changing the branch location if the customer wants to pick up the rental at a different place, etc.).

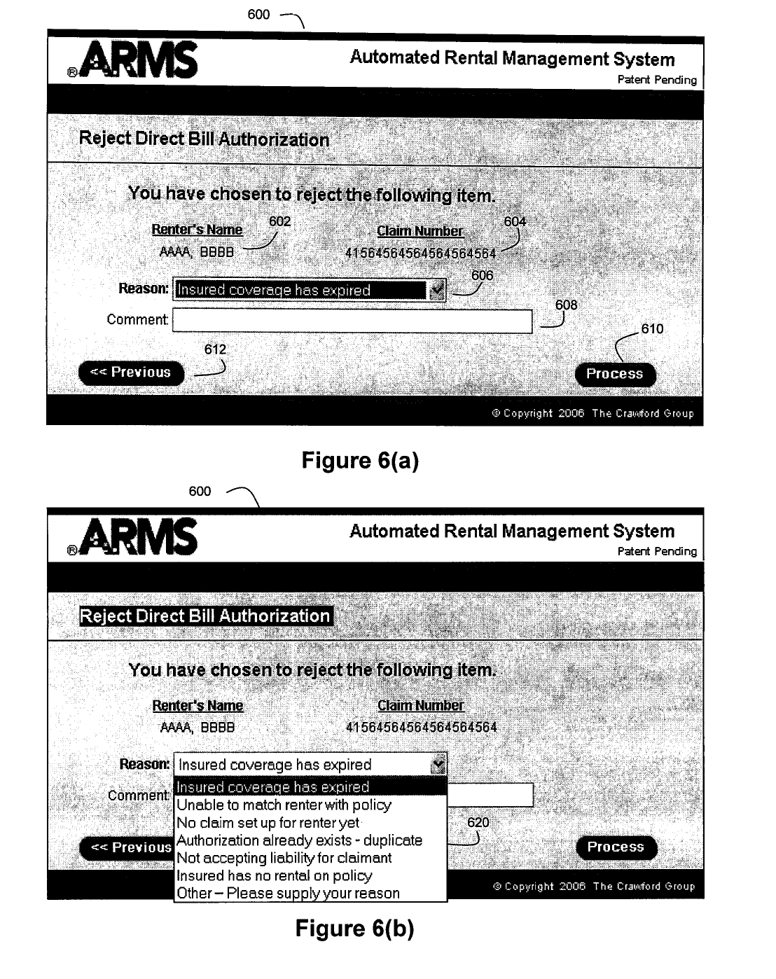

Furthermore, the user can also choose to cancel the pended reservation. Such cancellation may be necessary for any of a number of reasons (e.g., because the customer has waited too long to cash in the voucher (such as after the customer's damaged vehicle has been repaired and returned to him/her) or because the customer called to inform the user that he/she would not be needing a rental vehicle, or because of any of a number of other reasons). To do so, the user can select the “Cancel” button 416 of FIG. 4(a) (or FIG. 4(b)). Upon selection of the cancel button 416, the GUI screen 600 of FIG. 6(a) is preferably displayed on the adjuster's computer 102. Screen 600 preferably identifies in field 602 the name of the renter for whom the reservation is to be canceled and in field 604 the claim number corresponding to the reservation that is to be canceled. Through field 606, the user can enter a reason for the cancellation (preferably selected from a drop down menu 620 of pre-determined possible reasons, as shown in FIG. 6(b)). To proceed with the cancellation, the user can then select the “Process” button 610 to thereby cancel the pended reservation. To return to the screen of FIG. 4(a) (or FIG. 4(b)), the user can select the “Previous” button 612.

Upon selection of the “Confirm Reservation” button 414, the automated rental vehicle reservation management system 106 then transforms the “pended” reservation into a standard reservation that is recognized by system 106 for as being eligible fulfillment at a branch location of the rental vehicle service provider, thereby “unpending” the reservation (step 304).

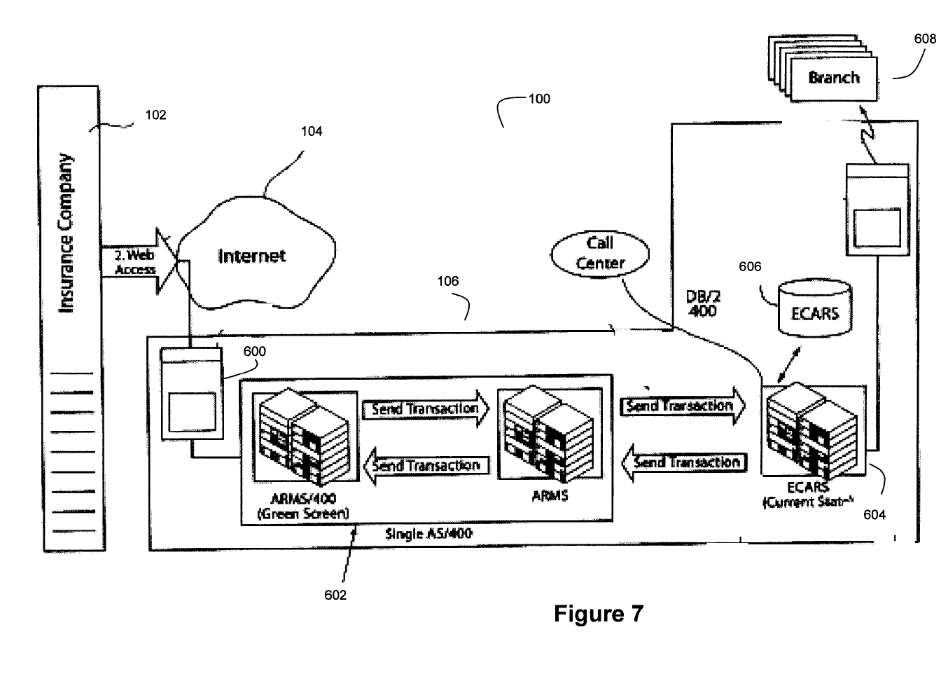

FIG. 7 depicts a first exemplary embodiment of the automated rental vehicle reservation management system 106, described in greater detail in connection with the above-referenced related patent applications. Preferably, system 106 of FIG. 7 is configured to store pended reservations created by users of the insurance company computer 102 in a database of mainframe 602. Once the adjuster has confirmed the pended reservation as described above, mainframe 602 is preferably configured to unpend the pended reservation and move the unpended reservation to database 606. Once stored in database 606, the fulfillment software resident on mainframe 604 (and executed via computers located in branch locations 608 of the rental vehicle service provider to thereby allow employees of the rental vehicle service provider to open and manage rental tickets for rental vehicles picked up at the branch locations 608) can then access the unpended reservation to open a rental ticket in accordance therewith when the insured/claimant arrives at the branch location to pick up the replacement rental vehicle corresponding to the voucher.

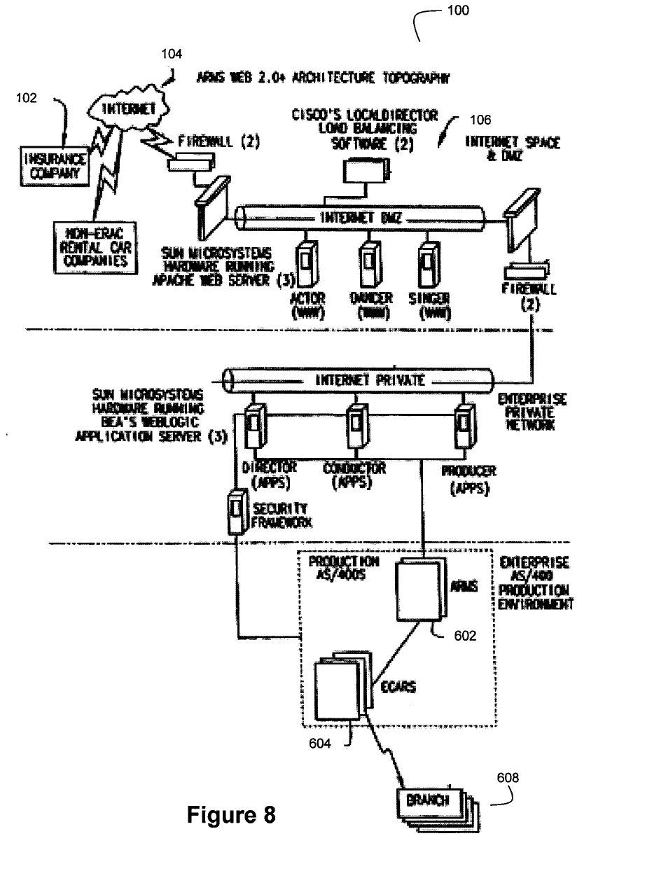

FIG. 8 depicts a second exemplary embodiment of the automated rental vehicle reservation management system 106, described in greater detail in connection with the above-referenced related patent applications. As with the embodiment of FIG. 7, system 106 of FIG. 8 is configured to store pended reservations created by users of the insurance company computer 102 in a database of mainframe 602. Once the adjuster has confirmed the pended reservation as described above, mainframe 602 is preferably configured to unpend the reservation and move the unpended reservation to a database of mainframe 604. Once stored in the database of mainframe 604, the fulfillment software resident on mainframe 604 (and executed via computers located in branch locations 608 of the rental vehicle service provider) can then access the unpended reservation to open a rental ticket in accordance therewith when the insured/claimant arrives at the branch location to pick up the replacement rental vehicle corresponding to the voucher.

While in the exemplary embodiments of FIGS. 7 and 8 step 304 involves moving the pended reservation from one physical database to another, it should be noted that step 304 can also be performed such that the reservation remains in the same physical database while the “pended” status flag is either removed from the reservation or a new flag is added to the reservation (such new flag identifying the formerly pended reservation as being an active reservation now recognized by system 106 as eligible for fulfillment), in either event such action transforming the reservation to convert that reservation into an active reservation like other standard reservations within system 106. As such, the unpended reservation becomes eligible for fulfillment via the fulfillment software. It should be noted that, as indicated above, the transformation of the reservation status from a pended status to an active status does not necessarily require the removal of the “pended” flag from the stored reservation. It may be desirable to keep a pended status flag stored in association with the reservation file so that reports can be more easily generated that provide statistics of interest concerning historical usage of pended reservations (e.g., the conversion rate of pended reservations to active reservations).

Once the pended reservation has been unpended, the reservation can then be fulfilled when the customer arrives at the branch location to pick up his/her replacement rental vehicle (step 306).

FIG. 3(b) depicts a process flow for a second exemplary method of activating a pended rental vehicle reservation corresponding to a voucher. With respect to the flow of FIG. 3(a), under the flow of FIG. 3(b), the customer is not required to contact his/her adjuster to activate the pended reservation and use the voucher. Instead, when the customer wants to use his/her voucher, he/she arrives at the rental branch location with his/her voucher (step 310). Then, at step 312, the fulfillment software executed by the branch location operates to match the customer's voucher with an existing confirmed reservation or an existing pended reservation stored by system 106. Any of a variety of matching metrics can be used to pair the customer's voucher with a stored reservation, including matching by voucher identifier and/or claim number, matching by renter name, a combination thereof, or matching by other means. If the customer's voucher is paired with an existing pended reservation, the fulfillment software can then operate to unpend the reservation at step 314 (wherein this unpending operation can be performed as described above in connection with step 304 of FIG. 3(a)). After the pended reservation has been unpended, a rental ticket in accordance with the unpended reservation can then be opened for the customer so that the customer can pick up his/her replacement rental vehicle (step 316).

FIG. 3(c) depicts a process flow for a third exemplary method of activating a pended rental vehicle reservation corresponding to a voucher. As with the flow of FIG. 3(b), under the flow of FIG. 3(c), the customer is not required to contact his/her adjuster to activate the pended reservation. Instead, a telephone number (such as a 1-800 number or the like) is provided to the customer, wherein the telephone number connects the customer to a call center or an automated call processing system through which the customer can activate the pended reservation corresponding to his/her voucher. Such a telephone number can be provided to the customer on the voucher. When the customer wants to use his/her voucher, he/she can call the telephone number (step 320). Preferably, an automated call processing system that is on the receiving end of the customer's telephone call then prompts the user to enter an identifier (via a voice or touchtone entries) for his/her voucher (preferably the claim number or voucher number). The automated call processing system is preferably in communication with system 106 so that the automated call processing system can perform the matching operation (step 322) described above for step 312 of FIG. 3(b) to pair the customer's voucher with an existing pended or unpended reservation stored by system 106. If the customer's voucher is paired with an existing pended reservation, then system 106 can operate to unpend the reservation at step 324 (wherein this unpending operation can be performed as described above in connection with step 304 of FIG. 3(a)). Once the pended reservation has been unpended, the reservation can then be fulfilled when the customer arrives at the branch location to pick up his/her replacement rental vehicle (step 326). It should be noted that the telephone number and its related call processing system can be maintained and operated by either of the insurance company and the rental car company (or even a third party working on their behalf/behalves).

FIG. 3(d) depicts a process flow for a fourth exemplary method of activating a pended rental vehicle reservation corresponding to a voucher. Similar in nature to the flow of FIG. 3(c), the flow of FIG. 3(d) contemplates that the customer can activate the pended reservation corresponding to his/her voucher through an Internet website. Preferably, the web address of the website is provided to the customer on the voucher. Using an Internet-connected computing device, the customer can then access a page of such a website, wherein the page is configured to prompt the user to enter an identifier (e.g., claim number or voucher number) for the voucher that he/she wishes to activate (step 330). Software that receives the identifier submitted by the customer through the website can then be used to perform the matching operation (step 332) described above for step 312 of FIG. 3(b) to pair the customer's voucher with an existing pended or unpended reservation stored by system 106. If the customer's voucher is paired with an existing pended reservation, then system 106 can operate to unpend the reservation at step 334 (wherein this unpending operation can be performed as described above in connection with step 304 of FIG. 3(a)). Once the pended reservation has been unpended, the reservation can then be fulfilled when the customer arrives at the branch location to pick up his/her replacement rental vehicle (step 336).

It should be noted that a practitioner of the present invention, may choose to implement only one of the activation methods described herein with system 100, or may choose to implement all of the activation methods described herein with system 100, or may choose any subcombination thereof.

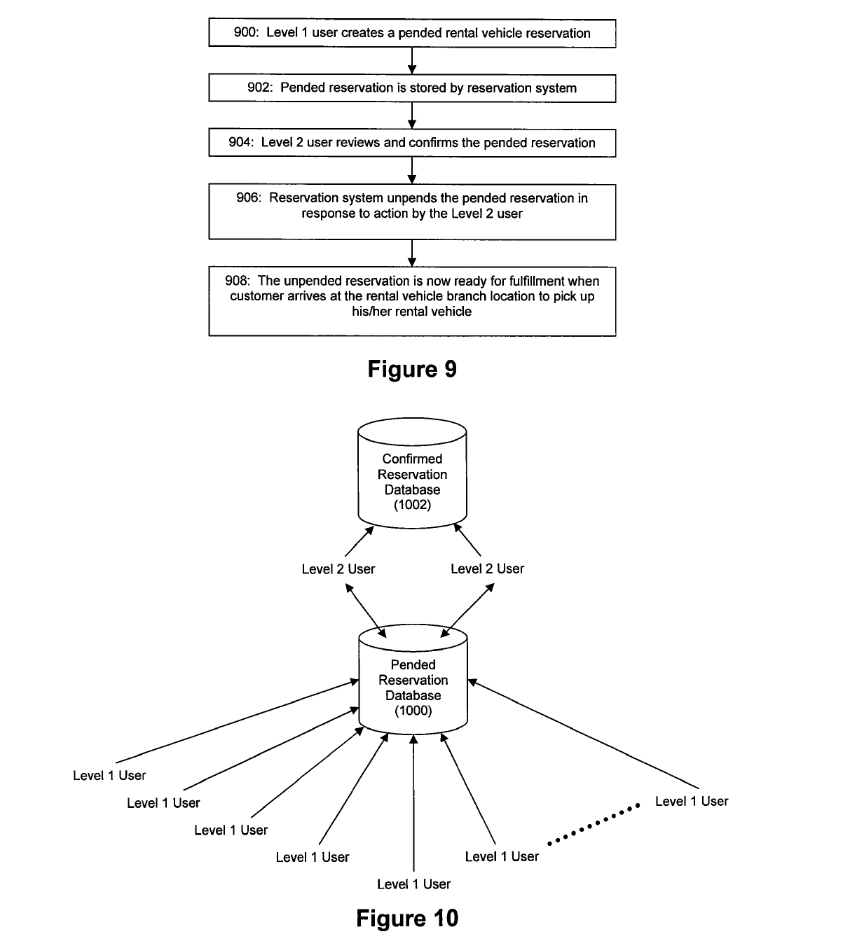

It should also be noted that the inventors herein contemplate uses for the “pended” status of reservations in areas beyond replacement rental vehicle reservations booked by insurance companies. For example, it should be noted that the pended status can be used in a reservation processing workflow wherein the business partner of the rental vehicle service provider has users of computer 102 with differing levels of approval authority in connection with creating and managing rental vehicle reservations. For example, the business partner may have “Level 1” users whose authority only extends to creating pended rental vehicle reservations. The business partner would then have “Level 2” users whose authority includes the ability to confirm the pended reservations created by Level 1 users. The process flow of FIG. 9 depicts an example of such a methodology.

At step 900, a Level 1 user creates a pended reservation as previously explained. To do so, the Level 1 user preferably accesses the automated rental vehicle management system 106 (preferably a GUI screen like the ones shown in FIG. 4(a) or 4(b) albeit such a screen would preferably not include the “Confirm Reservation” button if the user is only a Level 1 user) to create a pended reservation. At step 902, the pended reservation is stored by the automated rental vehicle reservation management system 106 (e.g., in a database of mainframe 602). Then, at step 904, a Level 2 user accesses the automated rental vehicle reservation management system 106 to review the pended reservation created by the Level 1 user. If the Level 2 user approves the pended reservation (possibly following modifications thereto entered through a GUI screen such as the ones shown in FIGS. 4(a) and (b)), the reservation system 106 then unpends the pended reservation as previously explained above (step 906). Following this unpending, the reservation can then be fulfilled when the customer arrives at the branch location to pick up his/her rental vehicle (step 908).

FIG. 10 depicts the workflow of FIG. 9, wherein multiple Level 1 users feed pended reservations to Level 2 users (preferably through a pended reservation database 1000). Level 1 users can optionally be organized into workgroups, wherein some subset of Level 1 users feed pended reservations to a particular Level 2 user. Level 2 users can then review the pended reservations created by their assigned Level 1 users to decide whether or not they should be confirmed (with confirmed reservations being stored in a confirmed reservation database 1002). Optionally, email notifications or other messages can be automatically sent to an appropriate Level 2 user when a Level 1 user creates a pended reservation. Furthermore, it should be noted that database 1000 and 1002 can optionally be a single database, wherein the action of confirming a pended reservation operates to remove the pended status from the stored reservation.

The embodiment of FIGS. 9 and 10, can be implemented in a variety of environments. For example, the Level 1 and Level 2 users can be employees of an insurance company with different levels of approval authority. As another example, the Level 1 and Level 2 users can be employees of a company wherein company employees often need to book rental vehicles as part of their jobs. In such cases, the Level 1 users could be company employees who book rental vehicles on their own behalf (e.g., salespeople) or on behalf of another employee (e.g., travel secretaries), and the Level 2 users could be company employees who are tasked with approving the travel and business expenses of company employees (e.g., personnel in a travel department of a company). Further still, the embodiments of FIGS. 9 and 10 can be implemented for companies that wish to limit the power of new employees when booking travel, in that new or probationary employees are assigned a Level 1 status while older nonprobationary employees are assigned the Level 2 status. Yet another environment for the deployment of the embodiments of FIGS. 9 and 10 would be in a call center environment, wherein specialists at the receiving end of telephone calls into the call center perform the data entry tasks related to creating a pended rental vehicle reservation (such specialists being assigned Level 1 status) and wherein the pended reservations created by the specialists are forwarded to the attention of Level 2 employees who are tasked with confirming or denying the pended reservations.

Preferably, the reservation system 106 is configured such that users thereof are assigned with various authority levels that define what actions they can take in the creation and management of rental vehicle reservations. Thus, upon a user logging into the reservation system from his/her computer 102, the reservation system 106 can determine the user's appropriate predetermined authority and limit the user's actions in accordance therewith.

Another preferred aspect of system 100 is that the automated rental vehicle reservation management system 106 be configured to purge stale pended reservations. This purging process can be run periodically to identify reservations that have remained in a pended status beyond a predetermined amount of time (e.g., 90 days). Upon identifying such stale pended reservations, the stale pended reservations can be automatically changed to a “canceled status” as they would be had the user canceled them through the screen 600 of FIGS. 6(a) and (b). It should also be noted that this purging process can be configured on a per business partner basis, wherein business partners have an associated profile that defines the criteria by which stored pended reservations are deemed stale. With such a configuration, Business Partner A may define a life of 30 days as the threshold for purging stored pended reservations, while Business Partner B defines a 90 day life therefor, while Business Partner C uses altogether different criteria (e.g., such as variable thresholds based on the end of the authorization period set forth for the pended reservations).

Another preferred aspect of system 100 is that the automated rental vehicle reservation management system 106 be configured to perform a matching operation that seeks to match existing pended reservations against rental tickets. Rental tickets are opened when a customer picks up a rental vehicle. Situations may arise where a customer with a voucher picks up a replacement rental vehicle as authorized by his/her voucher, but fails to present his/her voucher when doing so. Preferably, the customer informs the branch employee of the rental vehicle service provider that the rental is a replacement rental authorized by Insurance Company X. In such situations, the fulfillment software can be configured to readily identify whether any pended reservations exist for the customer using the information provided by the customer concurrently with or even before the opening the rental ticket.

However, in other situations, where a rental ticket may have been opened but without any pairing to an existing pending reservation, the system 106 can optionally be configured to still attempt to match existing pended reservations with rental tickets. In such situations, a rental ticket would presumably be created for the customer without knowledge of the existing pending reservation awaiting activation for that customer. Any of a variety of matching metrics can be used to match pended reservations to rental tickets as explained above, including matching based on the renter's name, as would be understood by those having ordinary skill in the art. Upon finding what is believed to be a match between a pended reservation and a rental ticket, system 106 can optionally send a message to an adjuster for approval of a pairing of the rental ticket with the pended reservation. Upon such approval by the adjuster, the system 106 can then unpend the reservation and merge it with the rental ticket. Such a matching process can be run periodically by the reservation system 106, or can be performed each time that a new rental ticket is opened.

Yet another preferred aspect of system 100 is that the automated rental vehicle reservation management system 106 be configured to provide reporting functionality to users of computer 102 that provide statistics regarding voucher-based reservations, including the reports that identify the percentage of pended reservations versus reservations that are active but were once pended—both voucher-specific and not voucher-specific (the voucher-specific report thereby indicating a usage rate for vouchers), reports that identify average rental terms for voucher-based reservations, and usage reports that detail statistics regarding authorized users' creation of and/or confirmation of pended reservations.

While the present invention has been described above in relation to its preferred embodiment, various modifications may be made thereto that still fall within the invention's scope, as would be recognized by those of ordinary skill in the art. Such modifications to the invention will be recognizable upon review of the teachings herein. For example, while the business partner that has been described in connection with an embodiment herein has been an insurance company, it should be noted that other business partners of the rental vehicle service provider can also practice the invention described herein, including but not limited to automobile dealers, leased vehicle fleet companies, or other companies having a recurring need to book rental vehicles on behalf of third parties. As such, the full scope of the present invention is to be defined solely by the appended claims and their legal equivalents.

What is claimed is:

1. A system for creating and managing a rental vehicle reservation, the system comprising:
a user computer; and
a reservation computer system that is in communication with the user computer via a network; and
wherein the reservation computer system is configured to accept input over the network from a user of the user computer to create a pended rental vehicle reservation for storage and processing by the reservation computer system.

2. The system of claim 1 wherein reservation computer system is further configured to accept input from the user over the network to confirm a pended rental vehicle reservation, the reservation computer system thereby unpending the pended reservation and transforming it to a standard rental vehicle reservation in response to said confirmation input.

3. The system of claim 2 wherein the reservation computer system comprises an automated rental vehicle reservation management system through which the user can create and manage rental vehicle reservations on behalf of third parties.

4. The system of claim 3 wherein the automated rental vehicle reservation management system comprises a first database in which pended rental vehicle reservations are stored and a second database in which unpended rental vehicle reservations are stored, and wherein the automated rental vehicle reservation management system is configured to unpend a pended rental vehicle reservation by moving it from the first database to the second database.

5. The system of claim 1 further comprising an automated call processing system in communication with the reservation computer system, wherein the automated call processing system is configured to (1) receive a telephone call from a renter, (2) prompt the user to input data that is sufficient to identify the pended reservation corresponding to a voucher held by the renter, (3) receive the prompted data from the renter, and (4) communicate the received data to the reservation computer system, and wherein the reservation computer system is further configured to (1) pair a pended rental vehicle reservation with the renter's voucher using the communicated data, and (2) unpend the paired pended rental vehicle reservation.

6. The system of claim 1 further comprising a website page for access by a person over the network, wherein the website page is configured to (1) accept data from the person that is sufficient to identify the pended reservation corresponding to a voucher held by a renter, and (2) communicate the data to the reservation computer system, and wherein the reservation computer system is further configured to (1) pair a pended rental vehicle reservation with the renter's voucher using the communicated data, and (2) unpend the paired pended rental vehicle reservation.

7. The system of claim 1 wherein the reservation computer system comprises an automated rental vehicle reservation management system through which the user can create and manage rental vehicle reservations on behalf of third parties, the automated rental vehicle reservation management system further comprising a fulfillment software program for execution by a computer at a branch location of a rental vehicle service provider, wherein the fulfillment software is configured to (1) search for a pended rental vehicle reservation stored by the automated rental vehicle reservation management system that corresponds to a voucher presented by a renter, and (2) unpend any stored pended rental vehicle reservation found by the search that corresponds to the voucher.

8. The system of claim 1 further comprising a plurality of the user computers, and wherein the reservation computer system comprises an automated rental vehicle reservation management system through which the users of the user computers can create and manage rental vehicle reservations on behalf of third parties, and wherein the automated rental vehicle reservation management system is configured to (1) assign the users with a plurality of different authority levels for creating and managing rental vehicle reservations, wherein a first plurality of the users are assigned with authority that includes an ability to create a pended rental vehicle reservation but does not include an ability to unpend a pended rental vehicle reservation, and wherein a second plurality of the users are assigned with authority that includes the ability to unpend a pended rental vehicle reservation, and (2) limit the users' interaction with the automated rental vehicle reservation management system in accordance with their assigned authority levels.

9. The system of claim 8 wherein the automated rental vehicle reservation management system is further configured to (1) define a plurality of workgroups, each workgroup comprising a plurality of the users within the first plurality of users and at least one of the users within the second plurality of users, and (2) notify the second plurality of users when users of the first plurality of users within their respective workgroups have created pended rental vehicle reservations.

10. The system of claim 1 wherein the user computer comprises a computer operated by an employee of an insurance company, and wherein the pended reservation corresponds to a reservation of a rental vehicle on behalf of an insured who has a need for a replacement rental vehicle under an insurance policy.

11. The system of claim 1 wherein the user computer comprises a computer operated by an employee of an insurance company, and wherein the pended reservation corresponds to a reservation of a rental vehicle on behalf of a claimant who has a need for a replacement rental vehicle under an insurance policy.

12. The system of claim 1 wherein the reservation computer system is further configured to generate a report in response to user input, the report providing statistics regarding transformation of pended reservations to standard reservations.

13. The system of claim 1 wherein the reservation computer system is further configured to purge pended rental vehicle reservations that have been stored by the reservation computer system beyond a predetermined amount of time.

14. The system of claim 1 wherein the reservation computer system is further configured to perform a matching operation that attempts to pair pended rental vehicle reservations with a corresponding rental ticket.

15. A system for creating and managing a plurality of rental vehicle reservations, the system comprising:
a user computer; and
a reservation computer system that is in communication with the user computer via a network; and
wherein the reservation computer system is configured to accept input over the network from a user of the user computer to create and manage rental vehicle reservations of at least two types, one type being a standard reservation intended for processing and fulfillment without further authorization and another type being a pended reservation.

16. A method for creating and managing a rental vehicle reservation, the method comprising:
creating, in a reservation computer system, a pended rental vehicle reservation for a person;
providing a voucher to the person, the voucher corresponding to the pended rental vehicle reservation;
receiving an indication from the person that the person intends to rent a rental vehicle in accordance with the voucher; and
within the reservation computer system, unpending the pended rental vehicle reservation in response to the received indication, thereby allowing the person to use the voucher when renting a rental vehicle.

17. The method of claim 16 further comprising:
opening a rental ticket for the person in accordance with the unpended rental vehicle reservation when the person arrives at a branch location of a rental vehicle service provider to rent a rental vehicle using the voucher.

18. The method of claim 16 wherein the unpending step comprises:
moving the pended rental vehicle reservation from a database in which pended rental vehicle reservations are stored to a database in which unpended rental vehicle reservations are stored.

19. The method of claim 16 wherein the indication receiving step comprises receiving a telephone call from the person.

20. The method of claim 19 wherein the telephone call comprises a telephone call to an automated call processing system, the automated call processing system being configured to interact with the person to obtain information sufficient to identify a pended rental vehicle reservation corresponding to the person's voucher, the indication receiving step further comprising:
automatically matching the person's voucher to a pended rental vehicle reservation using the information obtained from the person via the telephone call.

21. The method of claim 16 wherein the indication receiving step comprises receiving an email from the person.

22. The method of claim 16 further comprising providing a website through which the person can provide the indication that he/she intends to rent a rental vehicle in accordance with the voucher, and wherein the indication receiving step further comprises:
receiving information from the person through the website that is sufficient to identify a pended rental vehicle reservation corresponding to the person's voucher
automatically matching the person's voucher to a pended rental vehicle reservation using the information received from the person through the website.

23. The method of claim 16 wherein the voucher has an identifier associated therewith, wherein the indication receiving step comprises receiving at a branch location of a rental vehicle service provider a request from the person to use the voucher, and wherein the method further comprises;
Automatically matching the person's voucher to a pended rental vehicle reservation using the identifier associated with the voucher.

24. The method of claim 16 further comprising:
providing a reservation computer system through which a user can create and manage rental vehicle reservations via one or more graphical user interfaces (GUIs);
wherein the unpending step comprises (1) presenting a GUI to the user through which the user can review a pended reservation and choose to confirm the pended reservation, and (2) unpending the pended reservation in response to a confirmation received from the user through the GUI.

25. The method of claim 16 further comprising:
providing a reservation computer system through which a plurality of users can create and manage rental vehicle reservations;
assigning the users with a plurality of different authority levels for creating and managing rental vehicle reservations, wherein a first plurality of users are assigned with authority that includes an ability to create a pended rental vehicle reservation but does not include an ability to unpend a pended rental vehicle reservation, and wherein a second plurality of users are assigned with authority that includes the ability to unpend a pended rental vehicle reservation; and
limiting the users' interaction with the reservation computer system in accordance with their assigned authority levels.

26. The method of claim 25 wherein the users comprise insurance company personnel.

27. The method of claim 25 further comprising:
defining a plurality of workgroups, each workgroup comprising a plurality of the users within the first plurality of users and at least one of the users within the second plurality of users; and
notifying the second plurality of users when users of the first plurality of users within their respective workgroups have created pended rental vehicle reservations.

28. The method of claim 16 wherein the person comprises an insured who has a need for a replacement rental vehicle under an insurance policy.

29. The method of claim 16 wherein the person comprises a claimant who has a need for a replacement rental vehicle under an insurance policy.

30. The method of claim 16 wherein the voucher providing step comprises mailing a voucher to the person.

31. The method of claim 16 wherein the voucher providing step comprises communicating an electronic voucher to the person.

32. The method of claim 31 wherein the communicating step comprises emailing the electronic voucher to the person.

33. A method for processing a rental vehicle reservation, the method comprising:
storing in a reservation computer system a rental vehicle reservation corresponding to a voucher;
assigning a status to the rental vehicle reservation in response to input from a user, the status being stored by the reservation computer system and indicating that further authorization is required for the reservation to become active; and
transforming the assigned status in response to a further input to the reservation computer system, thereby activating the reservation in the reservation computer system.

34. The method of claim 33 wherein the rental vehicle reservation comprises a replacement rental vehicle reservation, wherein the user comprises an insurance adjuster, and wherein the person comprises an insured or a claimant.

35. The method of claim 34 wherein the status transforming step comprises transforming the assigned status in response to input received from the user that indicates a confirmation of the pended rental vehicle reservation by the user.

36. The method of claim 34 wherein the status transforming step comprises automatically transforming the assigned status in response to a matching operation that pairs the voucher with the stored rental vehicle reservation.

37. A method for creating and managing a rental vehicle reservation, the method comprising:
providing a reservation computer system through which a plurality of users can create and manage rental vehicle reservations;
assigning the users with a plurality of different authority levels for creating and managing rental vehicle reservations, wherein a first plurality of users are assigned with authority that includes an ability to create a pended rental vehicle reservation but does not include an ability to unpend a pended rental vehicle reservation, and wherein a second plurality of users are assigned with authority that includes the ability to unpend a pended rental vehicle reservation; and
limiting the users' interaction with the reservation computer system in accordance with their assigned authority levels.

38. The method of claim 37 wherein the users comprise a plurality of employees of a corporate customer of a rental vehicle service provider.

39. The method of claim 37 wherein the users comprise a plurality of employees of a vehicle fleet company.

40. The method of claim 37 wherein the first plurality of users comprise persons who are employees of a company and for whom the rental vehicle reservation is needed for business on behalf of the company, and wherein the second plurality of users comprise employees of the company who are tasked with approving business expenses of the company's employees.

41. The method of claim 37 wherein the users comprise insurance company personnel.

42. The method of claim 37 further comprising:
defining a plurality of workgroups, each workgroup comprising a plurality of the users within the first plurality of users and at least one of the users within the second plurality of users; and
notifying the second plurality of users when users of the first plurality of users within their respective workgroups have created pended rental vehicle reservations.

43. A system for creating and managing a rental vehicle reservation, the system comprising:
a reservation computer system configured to permit a plurality of users to create and manage rental vehicle reservations, the reservation computer system being further configured to (1) assign the users with a plurality of different authority levels for creating and managing rental vehicle reservations, wherein a first plurality of users are assigned with authority that includes an ability to create a pended rental vehicle reservation but does not include an ability to unpend a pended rental vehicle reservation, and wherein a second plurality of users are assigned with authority that includes the ability to unpend a pended rental vehicle reservation, and (2) limit the users' interaction with the reservation computer system in accordance with their assigned authority levels.

44. The system of claim 43 wherein the reservation computer system is further configured to (1) define a plurality of workgroups, each workgroup comprising a plurality of the users within the first plurality of users and at least one of the users within the second plurality of users, and (2) notify the second plurality of users when users of the first plurality of users within their respective workgroups have created pended rental vehicle reservations.
